(19) United States
(12) Patent Application Publication
(10) Pub. No.: US 2004/0151868 A1
(43) Pub. Date: Aug. 5, 2004

(54) Optical disk and method for manufacturing the same

(75) Inventors: Jin Hong Kim, Gyeonggi-do (KR); Jun Seok Lee, Chungcheongbuk-do (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/758,167

(22) Filed: Jan. 14, 2004

(30) Foreign Application Priority Data
Jan. 14, 2003 (KR) P2003-2454

(51) Int. Cl. G11B 7/24; G11B 7/26

(52) U.S. Cl. 428/65.1; 369/275.5; 369/288

(57) ABSTRACT

An optical disk for recording or/and reproducing information by using a laser beam includes a substrate formed by an inorganic material having elastic modulus of 2400 MPa or more, or a mixture of inorganic and plastic materials; a reflective layer formed on the substrate; a cover layer formed on the reflective layer; and a protective layer formed on the cover layer, wherein, the laser beam for recording or/and reproducing the information is incident on the protective layer and the cover layer.

This application claims the benefit of the Korean Application No. P2003-2454, filed on Jan. 14, 2003, which is hereby incorporated by reference.

### BACKGROUND OF THE INVENTION

1. Field of the Invention

The present invention relates to an optical disk and method for manufacturing the same, in which it is possible to record and reproduce information by using a laser source.

2. Description of the Related Art

After a CD type optical disk having a thickness of 1.2 mm and a diameter of 12 cm, a Digital Versatile Disk (DVD) type optical disk appears, which has a recording capacity of 4.7 Gbyte that is seven times greater than that of the CD type optical disk, 680 Mbyte. In this case, improvement of recording density is obtained by minuteness of optical spot, decrease of track pitch, and decrease of distance between light incident and reflective surfaces (thickness decrease CD: 1.2 mm, DVD: 0.6 mm).

The CD and DVD type optical disks commonly used in recent are divided into a Read-only memory (ROM) type, a Recordable (-R) type where information is written once, and a Rewritable (-RAM, -RW) type where information is read, written, and erased repetitively. In these optical disks, light of a laser source is transmitted to a reflective layer through a transparent substrate and an information-recording layer. Then, the light is reflected on the reflective layer, and is turned back to a photo director.

Meanwhile, in case next generation optical disks of high-density, it is required to obtain a light source of a short wavelength, or to increase NA (Numerical Apertures) of an object lens in order to improve recording capacity. Thus, a diameter of Beam Spot is decreased, whereby it is possible to manufacture the high-density optical disk having capacity of 20-25 GB.

However, as the object lens (for example, NA is about 0.85) having great NA is used with the short wavelength light source (for example, blue light source, having a wavelength of 407 nm), Coma aberration is increased with increase of a thickness of the substrate through which the laser light passes, so that it has a problem in that the objection lens is out of focus.

Also, in case of the high-density optical disk, when the disk is rotated at a high speed so as to increase a reproducing or recording speed, a distance between the disk and a pickup head is out of an effective distance due to vibration.

In this case, recording and reproducing signals are decreased rapidly, thereby generating distortion phenomenon. Especially, unlike a far field reproducing/recording method in which the distance between the disk and the pickup head is longer than the wavelength of the laser beam, in case a near field reproducing/recording method having the effective distance of 100 nm between the disk and the pickup head, the vibration characteristics of disk is very important with regard to the pickup head and disk interface. Thus, it is required to develop a disk having improved vibration characteristics greater than that of a prior disk so as to maintain a uniform minute distance. That is, it is necessary to obtain a stable disk having improved vibration characteristics, and improved shape and mechanical characteristics.

### SUMMARY OF THE INVENTION

Accordingly, the present invention is directed to an optical disk and method for manufacturing the same that substantially obviates one or more problems due to limitations and disadvantages of the related art.

An object of the present invention is to provide an optical disk and method for manufacturing the same, to obtain improved vibration characteristics, and improved shape and mechanical characteristics by increasing stiffness of the disk, for mass production.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an optical disk for recording or/and reproducing information by using a laser beam includes a substrate formed by an inorganic material having elastic modulus of 2400 MPa or more, or a mixture of inorganic and plastic materials; a reflective layer formed on the substrate; a cover layer formed on the reflective layer; and a protective layer formed on the cover layer, wherein, the laser beam for recording or/and reproducing the information is incident on the protective layer and the cover layer.

At this time, the information is recorded in the surface of the substrate, and a recording layer is formed between the reflective layer and the cover layer so as to record the information therein.

Also, dielectric layers are respectively formed between the substrate and the reflective layer, between the reflective layer and the recording layer, and between the recording layer and the cover layer.

The elastic modulus of the substrates is tensile and flexural modulus, and the substrate is formed of any one of Aromatic Polyether type material such as PEEK (Poly-ether-ether-ketone), PEK (Poly-ether-ketone), PPS (Poly-phenylene-sulfone), Bisphenol A polysulfone, and PES (Poly-ether-sulfone), Aromatic Polysulfide type material such as PPS (Poly (p-phenylene)sulfide or poly(thio-1,4-phenylene)), Aromatic Polyimide type material such as PI (Polyimide), PEI (Poly-ether-imide), PAI (Poly-amide-imide), BMI (Bismaleimide), LCP (Liquid Crystalline Polymer), and PMMA.

Also, the elastic modulus of the substrate is about 3200-3300 MPa, and the substrate is formed of polyetherimide resin.

Also, the substrates has an inside diameter of 1-15 mm, and an outside diameter of 15-57 mm. Further, a total thickness of the cover layer and the protective layer is about 10-220 μm, and a total thickness of the disk including the substrate is about 0.1-0.6 mm.

In another aspect, a method for manufacturing an optical disk includes the steps of preparing a stamper having a heat-insulation layer on an upper surface and a pit pattern on a lower surface, and an inorganic material having elastic modulus of 2400 MPa or more, or a mixture of inorganic and plastic materials; forming a substrate in an injection molding method at a temperature between 100° C. and 200° C. by using the stamper, the inorganic material or the mixture of inorganic and plastic materials; and sequentially forming a reflective layer, a cover layer and a protective layer on the substrate.

Further, a DLC (Diamond Like Carbon) layer is formed on the heat-insulation layer of the stamper, and a DLC (Diamond Like Carbon) layer is formed on the pit pattern of the stamper.

At this time, the heat-insulation layer of the stamper is formed of any one of a plastic material, an inorganic material, and a mixture of inorganic and plastic materials. The heat-insulation layer of the stamper is formed in a spin-coating method.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A is a cross-sectional view illustrating a ROM disk according to the preferred embodiment of the present invention;

FIG. 1B is a cross-sectional view illustrating a rewritable disk according to the preferred embodiment of the present invention;

FIG. 2 is a structure view illustrating an optical disk according to the preferred embodiment of the present invention;

FIG. 3 is a comparative table comparing polycarbonate for optical disks with resin used for the present invention;

FIG. 4 is a graph illustrating a temperature change of a fusion resin interface according to a thickness of a heat-insulation layer of a stamper;

FIG. 5A to FIG. 5C are graphs illustrating the modulus of printing and pattern depending on if a heat-insulation layer of a stamper is formed or not; and

FIG. 6A to FIG. 6C are tables illustrating natural frequency according vibration mode and the kind of resin.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, an optical disk and method for manufacturing the same according to the preferred embodiment of the present invention will be described with reference to the accompanying drawings.

In the present invention, a substrate is formed of plastic in order to obtain a disk having improved vibration characteristics, and improved shape and mechanical characteristics. In case the substrate is formed of plastic, it is possible to manufacture the substrate with simplified process steps by using injecting and compressing methods, to decrease manufacturing cost. Also, if the substrate is formed of plastic, it has no corrosion. Also, since the plastic is light, it is very useful to decrease resistance to spin motor.

The optical disk according to the present invention is formed of a material having great elastic modulus, so that it is easy to control threshold speed, natural frequency, and amplitude of vibration. Also, in the optical disk according to the present invention, a laser beam for recording/reproducing is incident on a protective layer instead of a substrate, whereby it is possible to form the substrate selectively with various materials. That is, the substrate may be formed of an opaque material having great elastic modulus without consideration for optical characteristics such as transparency and birefringence.

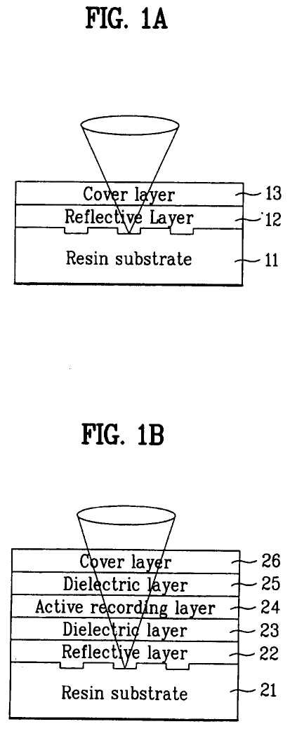

FIG. 1A is a cross-sectional view illustrating a ROM disk according to the preferred embodiment of the present invention. FIG. 1B is a cross-sectional view illustrating a rewritable disk according to the preferred embodiment of the present invention.

FIG. 1A illustrates a Read-only memory (ROM) disk, which includes a substrate 11, a reflective layer 12, and a cover layer 13. Also, a laser beam for reproducing is incident on the substrate 11 from the cover layer 13, whereby it is possible to reproduce information recorded in the surface of the substrate 11. In this case, the substrate 11 is formed of an inorganic material having elastic modulus of 2400 MPa or more, or a mixture of inorganic and plastic materials.

At this time, the elastic modulus of the substrate 11 means tensile and flexural modulus. The substrate 11 may be formed of any one of Aromatic Polyether type material such as PEEK (Poly-ether-ether-ketone), PEK (Poly-ether-ketone), PPS (Poly-phenylene-sulfone), Bisphenol A polysulfone, and PES (Poly-ether-sulfone), Aromatic Polysulfide type material such as PPS (Poly(p-phenylene)sulfide or poly(thio-1,4-phenylene)), Aromatic Polyimide type material such as PI (Polyimide), PEI (Poly-ether-imide), PAI (Poly-amide-imide), BMI (Bismaleimide), LCP (Liquid Crystalline Polymer), and PMMA.

FIG. 1B illustrates a rewritable disk, which includes a substrate 21, a reflective layer 22, a first dielectric layer 23, a recording layer 24, a second dielectric layer 25, and a cover layer 26. In addition, it is possible to form a protective layer on the cover layer 26. Then, a laser beam for reproducing is incident on the substrate 21 from the cover layer 26, to record or reproduce information in the recording layer 24. At this time, the substrate 21 is formed of an inorganic material having elastic modulus of 2400 MPa or more, or a mixture of organic and plastic materials.

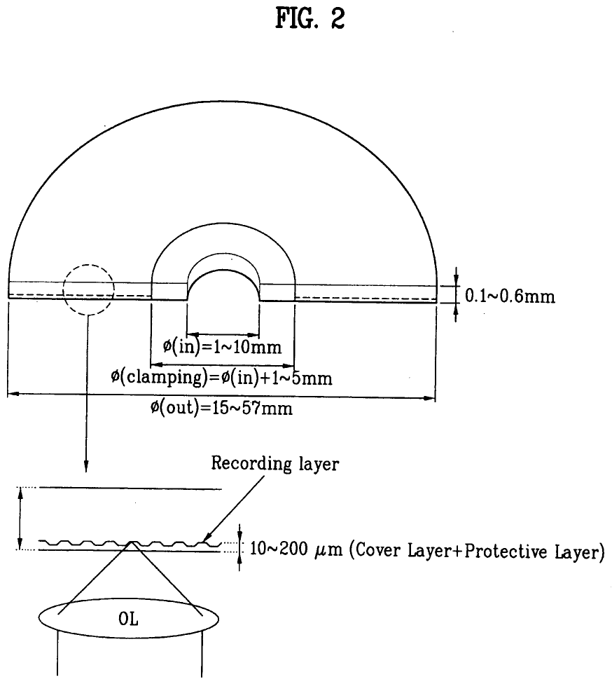

FIG. 2 illustrates an optical disk according to the preferred embodiment of the present invention. As shown in FIG. 2, an inside diameter of the substrate is about 1-15 mm, an outside diameter of the substrate is about 15-57 mm, a total thickness of the cover layer and the protective layer is about 10-200 μm, and a total thickness of the disk including the substrate is about 0.1-0.6 mm. Also, the elastic modulus of the substrate is about 3200-3300 MPa, and the substrate is formed of polyetherimide type resin.

However, the present invention is not limited to this preferred embodiment. That is, it is possible to form the optical disk according to the present invention in various shapes and with various materials. In this case, it is important to control an injection molding temperature for manufacturing the optical disk according to the present invention.

In case the injection molding is performed with the material having great elastic modulus, fusion viscosity of the resin is great, whereby fluidity of the resin is getting worse. Thus, a thickness of a solidified layer generated in a charging process is increased. That is, printing characteristics of patterns is deteriorated, whereby it is required to maintain higher injection molding temperature and resin fusion temperature than those of the related art.

Generally, the injection molding of polycarbonate is performed at a temperature of maximum 130° C. Meanwhile, in case of substrate materials of the present invention, it is required to maintain the temperature about 100-200° C. (preferably, about 160-200° C.). Thus, in the optical disk according to the present invention, a heat-insulation layer is formed on a rear surface of a stamper, and the disk is formed in the injection molding method.

In order to print the patterns of the stamper on the disk, it is important to control the temperature in the interface between the surface of the stamper and the fusion resin. Herein, the heat-insulation layer of the stamper delays the decrease of the temperature in the interference, whereby it helps the pattern printing process. At this time, the heat-insulation layer used in the present invention is formed of a plastic material, an inorganic material or a mixture material having low thermal conductivity and obtaining heat-resistance characteristics. Also, in order to obtain uniform heat-resistance, the heat-insulation layer is completely adhered to the stamper of nickel. Thus, the heat-insulation layer is formed in a method of spin-coating polyimide on the rear surface of the stamper, and performing a heat-hardening process thereto.

The heat-insulation layer is formed for improving the printing characteristics of patterns on the injection molding process with the material having great tensile and flexural modulus. Or, the heat-insulation layer coated on the rear surface of the stamper is hardened by heat, and then a DLC (Diamond Like Carbon) layer having low frictional modulus is additionally formed on the heat-insulation layer. In this case, the DLC layer is formed for decreasing the friction in the interface with a surface of a metal mold by pressure, thereby extending a life of the stamper. In addition, the DLC layer may be formed on a front surface of the stamper so as to control surface roughness of the patterns, and to improve nonstick characteristics.

A method for manufacturing the optical disk according to the present invention will be described as follows.

First, the stamper having the heat-insulation layer on an upper surface and the pit pattern on a lower surface is prepared. Also, it is required to prepare the inorganic material having the elastic modulus of 2400 MPa or more, or the mixture of the inorganic and plastic materials. Subsequently, the substrate is formed in the injection molding method at a temperature between 100° C. and 200° C. by using the stamper and the inorganic material or the mixture of the inorganic and plastic materials. Then, the reflective layer, the cover layer and the protective layer are sequentially formed on the substrate. At this time, the DLC layer may be formed on the heat-insulation layer of the stamper additionally, or the DLC layer may be formed on the pit pattern of the stamper additionally.

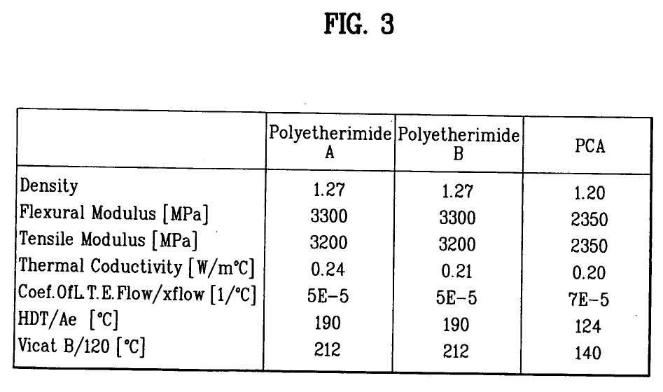

FIG. 3 is a comparative table comparing polycarbonate for optical disks with resin used for the present invention. On comparing polyetherimide A and B used in the present invention with polycarbonate used in the related art, a heat deflection temperature of polyetherimide A and B is higher than that of polycarbonate. Accordingly, since the substrate of the present invention is formed of polyetherimide A and B, the substrate of the present invention has great heat stability.

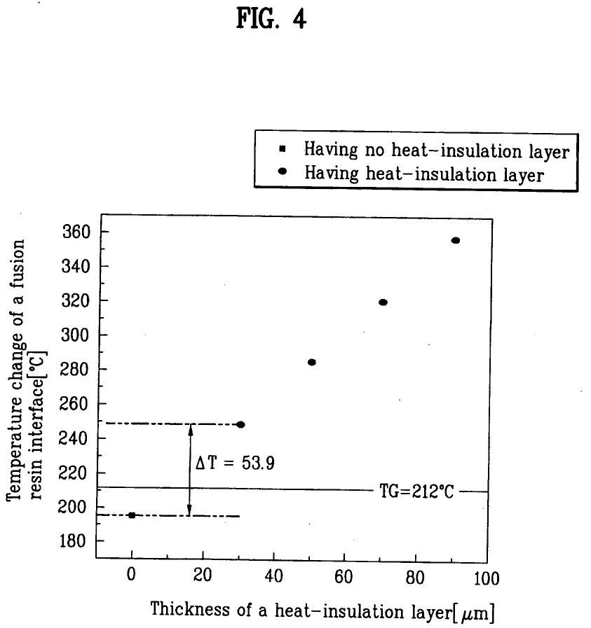

FIG. 4 is a graph illustrating temperature change of fusion resin interface according to the thickness of the heat-insulation layer of the stamper. As shown in FIG. 4, in case of using the stamper having the heat-insulation layer of 30 μm thickness, the temperature of fusion resin interface is higher about 54° C. than that in case of using the stamper having no heat-insulation layer. When forming the substrate for the optical disk with the stamper having uniform groove depth, the temperature difference of the interface has effects on the groove depth printed on the substrate.

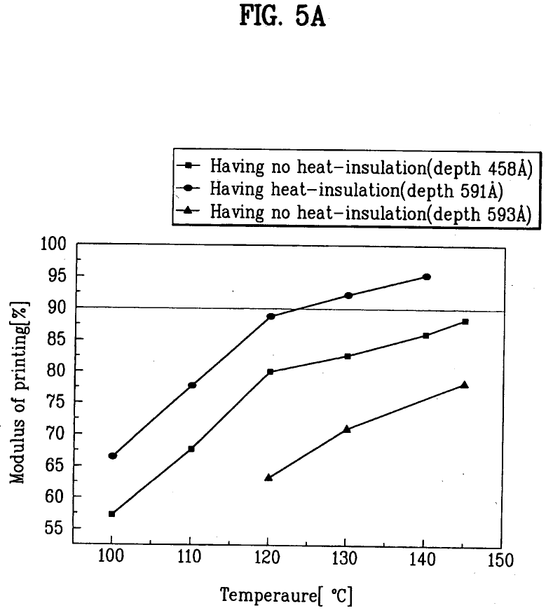

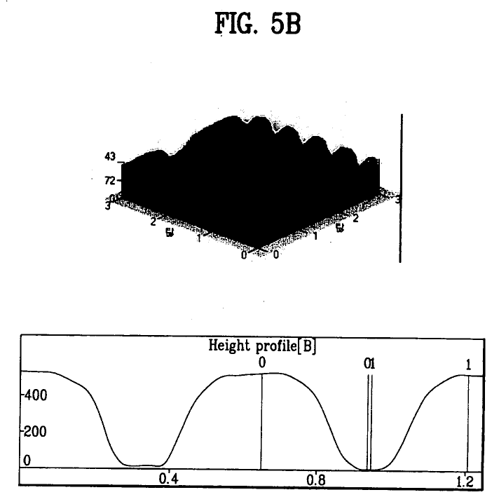

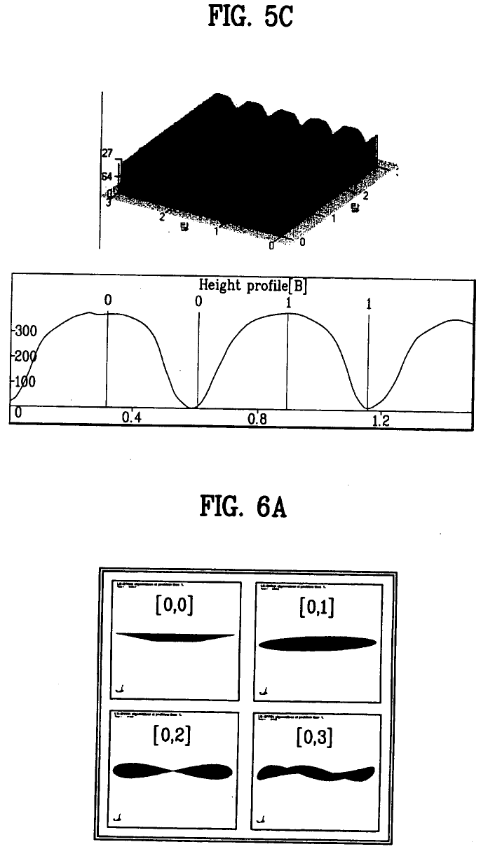

FIG. 5A to FIG. 5C are graphs illustrating the modulus of printing and the pattern depending on if the heat-insulation layer of the stamper is formed or not.

As shown in FIG. 5A, in case of the stamper having the heat-insulation layer, the modulus of pattern printing is at about 95%. Meanwhile, in case there is no heat-insulation layer in the stamper, the modulus of pattern printing is at about 75%.

FIG. 5B illustrates the pattern of the substrate in case of using the stamper having the heat-insulation layer of 30 μm thickness when the temperature is at about 140° C. FIG. 5C illustrates the modulus of printing in the substrate in case of using the stamper having no heat-insulation layer when the temperature is at about 145° C.

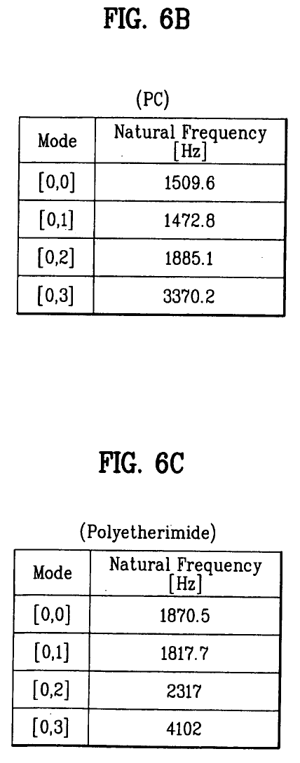

FIG. 6A to FIG. 6C are tables illustrating natural frequency according to the vibration mode and the kind of resin. That is, FIG. 6A to FIG. 6C illustrate simulation results of changed values in the natural frequency according to the vibration mode and the kind of resin when using a small-sized disk having an outside diameter at about 30 mm.

FIG. 6A illustrates the vibration mode, FIG. 6B illustrates the natural frequency of polycarbonate, and FIG. 6C illustrates the natural frequency of polyetherimide resin. In case of the polyetherimide resin used in the substrate according to the present invention, it has tensile and flexural modulus of 3200-3300 MPa that is greater than that of polycarbonate, whereby it is useful to increase the natural frequency and to decrease the amplitude of the disk.

As mentioned above, the optical disk according to the present invention and the method for manufacturing the same have the following advantages.

With the present invention, it is possible to develop the small-sized disk having great capacity of high-density as compared to the prior art CD or DVD, for supplementary store media substituting for PDA, mobile PC, digital camera and CD-ROM.

Also, since stiffness of substrate increases, it is possible to decrease the amplitude of the disk by increasing the threshold speed and the natural frequency.

In the present invention, the substrate having stiffness is formed in the injection molding method, thereby realizing mass production.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An optical disk for recording or/and reproducing information by using a laser beam comprising:
a substrate formed by an inorganic material having elastic modulus of 2400 MPa or more, or a mixture of inorganic and plastic materials;
a reflective layer formed on the substrate;
a cover layer formed on the reflective layer; and
a protective layer formed on the cover layer,
wherein, the laser beam for recording or/and reproducing the information is incident on the protective layer and the cover layer.

2. The optical disk as claimed in claim 1, wherein the information is recorded in the surface of the substrate.

3. The optical disk as claimed in claim 1, wherein a recording layer is formed between the reflective layer and the cover layer so as to record the information therein.

4. The optical disk as claimed in claim 3, wherein dielectric layers are respectively formed between the substrate and the reflective layer, between the reflective layer and the recording layer, and between the recording layer and the cover layer.

5. The optical disk as claimed in claim 1, wherein the elastic modulus of the substrates is tensile and flexural modulus.

6. The optical disk as claimed in claim 1, wherein the substrate is formed of any one of Aromatic Polyether type material such as PEEK (Poly-ether-ether-ketone), PEK (Poly-ether-ketone), PPS (Poly-phenylene-sulfone), Bisphenol A polysulfone, and PES (Poly-ether-sulfone), Aromatic Polysulfide type material such as PPS (Poly(p-phenylene)sulfide or poly(thio-1,4-phenylene)), Aromatic Polyimide type material such as PI (Polyimide), PEI (Poly-ether-imide), PAI (Poly-amide-imide), BMI (Bismaleimide), LCP (Liquid Crystalline Polymer), and PMMA.

7. The optical disk as claimed in claim 1, wherein the elastic modulus of the substrate is about 3200-3300 MPa, and the substrate is formed of polyetherimide resin.

8. The optical disk as claimed in claim 1, wherein the substrates has an inside diameter of 1-15 mm, and an outside diameter of 15-57 mm.

9. The optical disk as claimed in claim 1, wherein a total thickness of the cover layer and the protective layer is about 10-220 μm, and a total thickness of the disk including the substrate is about 0.1-0.6 mm.

10. A method for manufacturing an optical disk comprising:
preparing a stamper having a heat-insulation layer on an upper surface and a pit pattern on a lower surface, and an inorganic material having elastic modulus of 2400 MPa or more, or a mixture of inorganic and plastic materials;
forming a substrate in an injection molding method at a temperature between 100° C. and 200° C. by using the stamper, the inorganic material or the mixture of inorganic and plastic materials; and
sequentially forming a reflective layer, a cover layer and a protective layer on the substrate.

11. The method as claimed in claim 10, further comprising a DLC (Diamond Like Carbon) layer on the heat-insulation layer of the stamper.

12. The method as claimed in claim 10, further comprising a DLC (Diamond Like Carbon) layer on the pit pattern of the stamper.

13. The method as claimed in claim 10, wherein the heat-insulation layer of the stamper is formed of any one of a plastic material, an inorganic material, and a mixture of inorganic and plastic materials.

14. The method as claimed in claim 13, wherein the heat-insulation layer of the stamper is formed in a spin-coating method.
